(19) United States
(12) Patent Application Publication
(10) Pub. No.: US 2026/0320655 A1
(43) Pub. Date: Oct. 15, 2026

(54) METHOD FOR GENERATING ADVERTISEMENTS LINKED TO MULTIPLE DESTINATIONS

(71) Applicant: Bytedance Technology Ltd., Grand Cayman (KY)

(72) Inventors: Gary CHANG, Beijing (CN); Ru JIA, Los Angeles, CA (US); Weihao XU, Los Angeles, CA (US); Xubo TANG, Beijing (CN); Quanbin ZHENG, Beijing (CN); Dexuan DU, Beijing (CN); Meng LIU, Beijing (CN); Xingcheng ZHANG, Beijing (CN); Jianye LIU, Beijing (CN)

(21) Appl. No.: 19/174,777

(22) Filed: Apr. 9, 2025

(51) Int. Cl. G06Q 30/0241

(52) U.S. Cl. CPC G06Q 30/0276

(57) ABSTRACT

Methods, systems, and apparatus, including computer programs encoded on computer storage media, for generating advertisements linked to multiple destination websites. One example method includes: receiving setup information of a plurality of products to be displayed in an advertisement; providing a plurality of entry points to be displayed with the advertisement, wherein the plurality of entry points comprises a plurality of product cards corresponding to the plurality of products, each product card of the plurality of product cards is set to be displayed with a corresponding product among the plurality of products; and setting destinations for the plurality of product cards, wherein for each product card of the plurality of product cards, a destination of each product card comprises product information of a corresponding product displayed with each product card.

### TECHNICAL FIELD

This specification relates to the generation of advertisements, and in particular, to generating advertisements associated with a plurality of destinations.

### BACKGROUND

In the digital market, providing advertisements together with an inventory of advertised products is desirable for advertisers. Dynamically displaying inventory information of the advertised products facilitates potential buyers ordering the advertised products. For example, in the automotive industry field, car dealerships use automative inventory advertisements to display specific information about an automative inventory, so as to generate potential buyers' interest in advertised vehicles, and to further direct them to corresponding web pages, for example, an official website of the vendor, product introduction pages, etc.

### SUMMARY

This specification describes technologies for generating advertisements that are linked to multiple destinations.

According to a first aspect, a computer-implemented method is provided. The computer-implemented method comprises: receiving setup information of a plurality of products to be displayed in an advertisement; determining a plurality of entry points to be displayed with the advertisement, wherein the plurality of entry points comprises a plurality of product cards corresponding to the plurality of products, each product card of the plurality of product cards is set to be displayed with a corresponding product among the plurality of products; and setting destinations for the plurality of product cards, wherein for each product card of the plurality of product cards, a destination of each product card comprises product information of a corresponding product displayed with each product card.

With reference to the first aspect, in some implementations, the setup information comprises a product catalog, and the product catalog comprises product parameters for each of the plurality of products.

With reference to the first aspect, in some implementations, the setting destinations for the plurality of product cards comprises, for each product card of the plurality of product cards: retrieving a destination of each product card from the product catalog based on product parameters of the corresponding product displayed with each product card.

With reference to the first aspect, in some implementations, in response to receiving, from a user, a user action associated with each product card, directing the user to a website page comprising the product information of the corresponding product displayed with each product card.

With reference to the first aspect, in some implementations, the plurality of entry points further comprises an inventory card, and the computer-implemented method further comprises: setting a destination of the inventory card to a website page comprising inventory information of the plurality of products.

With reference to the first aspect, in some implementations, the plurality of entry points is displayed in one or more formats consisting of: profile pictures, call-to-action (CTA) button, cards, or advertisement content.

With reference to the first aspect, in some implementations, further including: for each of the plurality of products, displaying a product with one or more of the entry points, wherein the one or more of the entry points have same destination, wherein the destination comprises product information of the product.

According to a second aspect, one or more non-transitory computer-readable storage media is provided. The one or more computer-readable storage media stores one or more instructions that, when executable by one or more computers, cause the one or more computers to perform operations comprising: receiving setup information of a plurality of products to be displayed in an advertisement; determining a plurality of entry points to be displayed with the advertisement, wherein the plurality of entry points comprises a plurality of product cards corresponding to the plurality of products, each product card of the plurality of product cards is set to be displayed with a corresponding product among the plurality of products; and setting destinations for the plurality of product cards, wherein for each product card of the plurality of product cards, a destination of each product card comprises product information of a corresponding product displayed with each product card.

With reference to the second aspect, in some implementations, the setup information comprises a product catalog, and the product catalog comprises product parameters for each of the plurality of products.

With reference to the second aspect, in some implementations, the setting destinations for the plurality of product cards comprises, for each product card of the plurality of product cards: retrieving a destination of each product card from the product catalog based on product parameters of the corresponding product displayed with each product card.

With reference to the second aspect, in some implementations, further comprising: in response to receiving, from a user, a user action associated with each product card, directing the user to a website page comprising the product information of the corresponding product displayed with each product card.

With reference to the second aspect, in some implementations, the plurality of entry points further comprises an inventory card, and the operations further comprise: setting a destination of the inventory card to a website page comprising inventory information of the plurality of products.

With reference to the second aspect, in some implementations, the plurality of entry points is displayed in one or more formats consisting of: profile pictures, call-to-action (CTA) button, cards, or advertisement content.

With reference to the second aspect, in some implementations, further comprising, for each of the plurality of products: displaying a product with one or more of the entry points, wherein the one or more of the entry points have same destination, wherein the destination comprises product information of the product.

According to a third aspect, a computer-implemented system is provided. The computer-implemented system comprises: one or more computers; and one or more computer memory devices interoperably coupled with the one or more computers and having non-transitory computer-readable storage media storing one or more instructions that, when executed by the one or more computers, perform one or more operations comprising: receiving setup information of a plurality of products to be displayed in an advertisement; determining a plurality of entry points to be displayed with the advertisement, wherein the plurality of entry points comprises a plurality of product cards corresponding to the plurality of products, each product card of the plurality of product cards is set to be displayed with a corresponding product among the plurality of products; and setting destinations for the plurality of product cards, wherein for each product card of the plurality of product cards, a destination of each product card comprises product information of a corresponding product displayed with each product card.

With reference to the third aspect, in some implementations, the setup information comprises a product catalog, and the product catalog comprises product parameters for each of the plurality of products.

With reference to the third aspect, in some implementations, the setting destinations for the plurality of product cards comprises, for each product card of the plurality of product cards: retrieving a destination of each product card from the product catalog based on product parameters of the corresponding product displayed with each product card.

With reference to the third aspect, in some implementations, further comprising: in response to receiving, from a user, a user action associated with each product card, directing the user to a website page comprising the product information of the corresponding product displayed with each product card.

With reference to the third aspect, in some implementations, the plurality of entry points further comprises an inventory card, and the one or more operations further comprises: setting a destination of the inventory card to a website page comprising inventory information of the plurality of products.

With reference to the third aspect, in some implementations, the plurality of entry points is displayed in one or more formats consisting of: profile pictures, call-to-action (CTA) button, cards, or advertisement content, and wherein the one or more operations further comprises, for each of the plurality of products: displaying a product with one or more of the entry points, wherein the one or more of the entry points have same destination, wherein the destination comprises product information of the product.

According to a second aspect, one or more computer-readable storage media is provided. The one or more computer-readable storage media stores one or more instructions that, when executable by one or more computers, cause the one or more computers to perform the method according to the first aspect or one or more implementations of the first aspect.

According to a third aspect, a computer-implemented system is provided. The computer-implemented system includes one or more computers and one or more computer memory devices interoperably coupled with the one or more computers. The one or more computer memory devices have computer-readable storage media storing one or more instructions that, when executed by the one or more computers, perform the method according to the first aspect or one or more implementations of the first aspect.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic diagram of an example process of generating an advertisement.

FIG. 2 is an example catalog including a plurality of products.

FIG. 3 is an illustration diagram of an example video advertisement displaying with a plurality of entry points.

FIGS. 4A to 4C illustrate fragments corresponding to a plurality of products in a video advertisement, respectively.

FIG. 5 is a flowchart of an example process for generating advertisements that are linked to multiple destinations.

FIG. 6 is an example computing system.

Like reference numbers and designations in the various drawings indicate like elements.

### DETAILED DESCRIPTION

The following detailed description describes generating advertisements that are linked to multiple destinations and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

Inventory advertisements allow advertisers (such as vendors or sellers) to show their real-time inventory directly to users (such as potential buyers). In general, an advertiser generates an inventory advertisement offering a single call-to-action (CTA) button for the users. By clicking the CTA button, the users can be redirected to a predetermined destination to view the inventory information. However, the aforementioned inventory advertisement only allows the users to be redirected using a fixed Uniform Resource Locator (URL) to only one predetermined web page.

Techniques described in this disclosure can help provide techniques for generating advertisements that are linked to multiple destinations. In some implementations, the described techniques can generate advertisements including several different products that allow the users to be redirected to different product pages. As an example method of the present disclosure, in some implementations, setup information of a plurality of products to be displayed in an advertisement is received, and a plurality of entry points to be displayed with the advertisement is determined. In some implementations, the plurality of entry points includes a plurality of product cards corresponding to the plurality of products, and each product card of the plurality of product cards is set to be displayed with a corresponding product among the plurality of products. In some implementations, destinations are set for the plurality of product cards. For each product card of the plurality of product cards, product information of the corresponding product displayed with each product card is included in the destination of each product card.

The described techniques can achieve one or more technical benefits/advantages. In some implementations, the described techniques allow an advertisement to link to different destinations. For example, by determining a plurality of product cards corresponding to the plurality of products included in the advertisement as entry points and setting a different destination for each product card, the described techniques allow the users to be directed to different destinations by performing user actions associated with different product cards. In some implementations, the described techniques also allow dynamically displaying multiple products and links to their corresponding product pages. For example, by setting each product card of the plurality of product cards to be displayed with a corresponding product among the plurality of products included in the advertisement, and causing the destination of each product card includes product information of the corresponding product displayed with each product card, the described techniques allow each of the multiple products included in the advertisement to have a corresponding destination to which a user can be directed. In some implementations, the described techniques also provide different entrances for jumping to product pages. For example, by determining a plurality of entry points to be displayed with the advertisement, the users are more likely to be redirected to the product pages. In some implementations, different or additional advantages can be achieved.

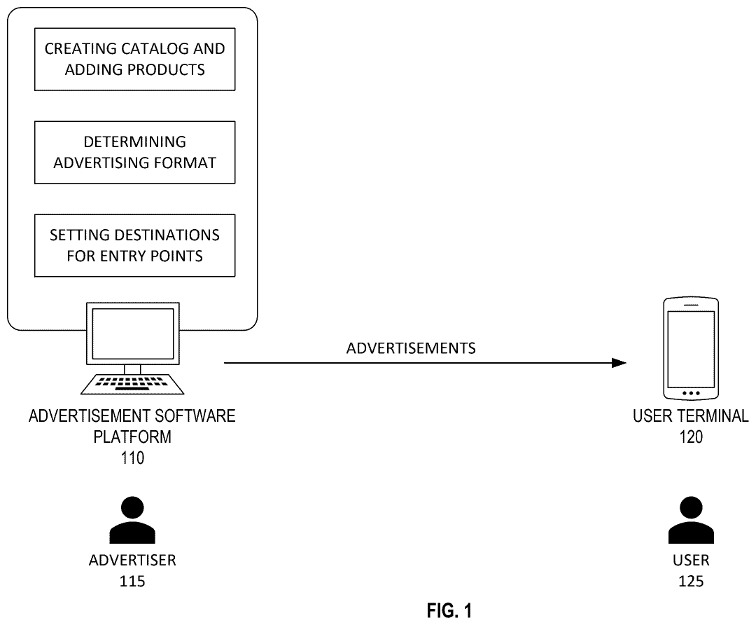

FIG. 1 is a schematic diagram of an example process of generating an advertisement. As shown in FIG. 1, an advertisement may be generated, by an advertiser 115, at an advertisement software platform 110. In some implementations, the advertiser 115 can be a vendor or a dealership. For example, a catalog including a plurality of products may be created, by the advertiser 115 using the advertisement software platform 110. In some implementations, the process of creating a catalog includes providing the advertisement software platform 110 with specific information related to, for example, a name of the catalog, an industry corresponding to the products to be advertised, a target market, a default currency, and other relevant information.

In some implementations, the process of creating the catalog further includes adding products to be advertised or planned to be advertised to the catalog. There are several methods to add products to the catalog. In some implementations, the products may be manually added. For example, the products are added by the advertiser 115 manually filling out a form for each product to be advertised or planned to be advertised. In some implementations, the products may be added by feeding data to the advertisement software platform 110. For example, the advertiser 115 may add the products to the catalog by uploading from an online file corresponding to products. In some cases, such a method allows the advertiser 115 to set a schedule for automatically updating the products in the catalog at predetermined intervals. In some other implementations, the products may be added by uploading product files using a template.

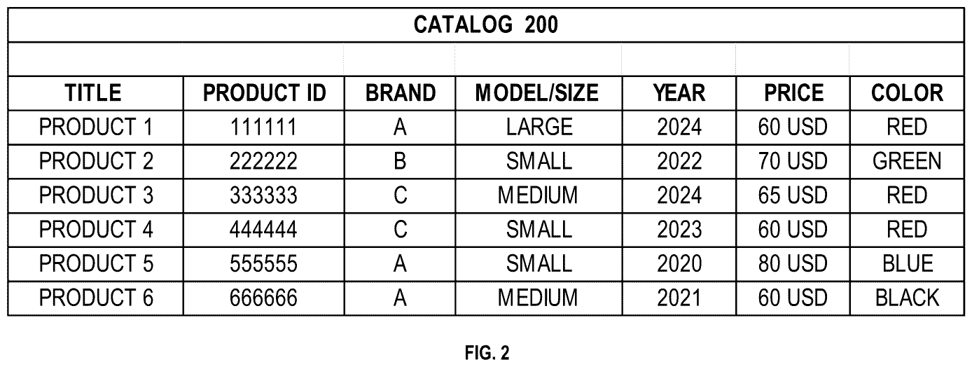

FIG. 2 shows an example catalog 200 including a plurality of products. In FIG. 2, the example catalog 200 includes six products and corresponding product information for each product. The product information includes parameters such as title of the product, the product ID, brand name, model or size of the product, manufacturing year, retail price, color, etc. In some implementations, the plurality of products can be viewed, filtered, and/or sorted, using the parameters in the catalog.

In some implementations, an advertising format for an advertisement can be determined by the advertiser 115 using the advertisement software platform 110. The advertising format may include, for example, video and carousel. These advertising formats allow combining multiple videos or images of different products into a single advertisement. As an example, the advertisement may be determined in a video format and include a number of videos, where each video corresponds to a different product. As an example, the advertisement may be determined in a carousel format and include a number of images corresponding to a number of different products.

In some implementations, a plurality of entry points to be displayed with the advertisement may be determined, by the advertiser 115, at the advertisement software platform 110. The entry points include, for example, profile pictures, CTA buttons, product cards, inventory cards, title, content of the advertisement, etc.

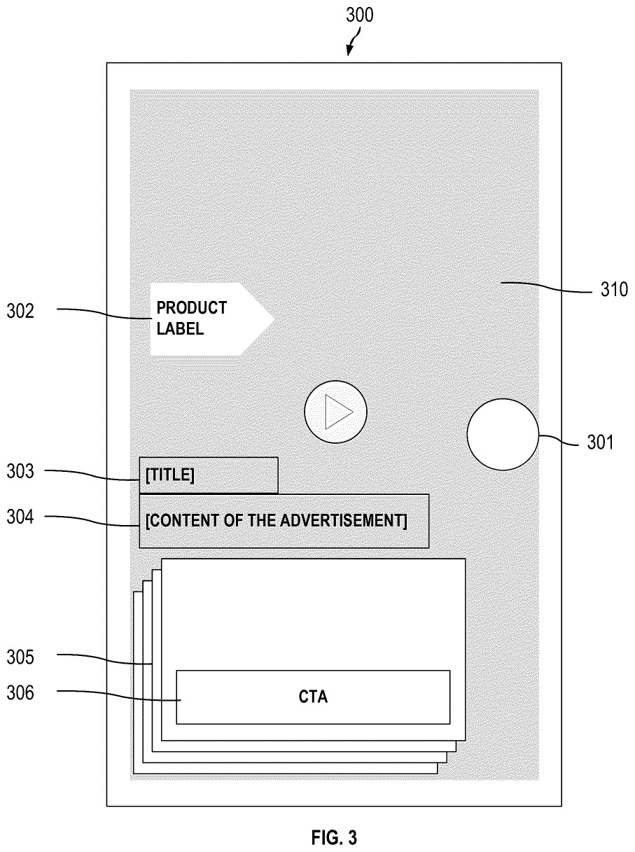

FIG. 3 shows an illustration diagram of an example video advertisement displaying with a plurality of entry points. In FIG. 3, an advertisement 300 includes a main portion 310 for displaying the advertised products and a plurality of entry points, including: a profile picture 301, a product label 302, a title 303, a content of the advertisement 304, product cards 305, and a CTA button 306. In some implementations, entry points can be used to present product information. For example, the product label 302 can be used to present information such as brand name, model or size of the product, and manufacturing year. The content of the presented information can be retrieved from the catalog (such as the catalog 200 of FIG. 2). As another example, the product cards 305 can be used to present information such as a photo of the product, retail price, and a brief description of the product. In this case, the plurality of entry points enables users to directly learn some important parameters of the product, thus encouraging the users to perform subsequent user actions and increasing the conversion rate.

In some implementations, a plurality of product cards is included in the plurality of entry points, and each product card corresponds to a different advertised product displayed in the advertisement. For example, in response to determining a number of advertised product to be displayed in the advertisement, determining, at the advertisement software platform 110, a number of the product cards, wherein the number of the product cards is the same as the number of advertised product. In some implementations, for each product card, a destination is set at the advertisement software platform 110, wherein the destination refers to a website including product information of the advertised product corresponding to the product card. As an example, the destination is a product page of the corresponding advertised product, and thereby a user may be redirected to a corresponding product page in response to a user action associated with a product card (such as clicking the product card). In some implementations, the destination for each product card may be retrieved from the catalog. For example, the destination for each product card may be automatically retrieved based on the parameters of the products in the catalog.

In some implementations, an inventory card is included in the plurality of entry points. The inventory card is used for redirecting a user to destination showing inventory information of the advertised products. In some implementations, the destination of the inventory card may be set, at the advertisement software platform 110, to an inventory page including a number of available products, so that in response to a user action associated with the inventory card (such as clicking the inventory card), a user may be redirected to the inventory page to check the inventory information. As an example, the destination of the inventory card may be set to link to a fixed URL for the inventory page.

In some implementations that advertisement is determined as a carousel advertisement, the plurality of entry points may include a plurality of product images. For each product image, a destination is set using the advertisement software platform 110, wherein the destination refers to a website including information of the advertised product in the product image. Similarly, in this case, a user may be redirected to the product page corresponding to the product in the image in response to a user action associated with the product image (such as clicking the product image). In some implementations, the destination for each product image may be retrieved from the catalog. For example, the destination for each product image may be automatically retrieved based on the parameters of the products in the catalog. In such implementations, the plurality of entry points may also include an end card. In some implementations, the destination of the end card may be set, at the advertisement software platform 110, to an inventory page including a number of available products included in the carousel advertisement. Thereby, in response to a user action associated with the end card (such as clicking the end card), the end card allows a user to be redirect to the inventory page and browse the full inventory. In some implementations, the destination of the end card is set to link to a fixed URL for the inventory page.

In some implementations, in response to generating the advertisement at the advertisement software platform 110, the advertisement is sent to a user terminal 120 for viewing by a user 125. The user terminal 120 can be, for example, a mobile phone, a tablet computer, a laptop, etc. In some implementations, the user may view the advertisement including the plurality of products, and may be redirected to different product pages corresponding to the plurality of products by clicking different entry points. For example, the user 125 views a video advertisement including three products (that is, product A, product B, and product C) at the user terminal 120. The three products are displayed in the video advertisements successively, and each of the three products are displayed with a plurality of entry points.

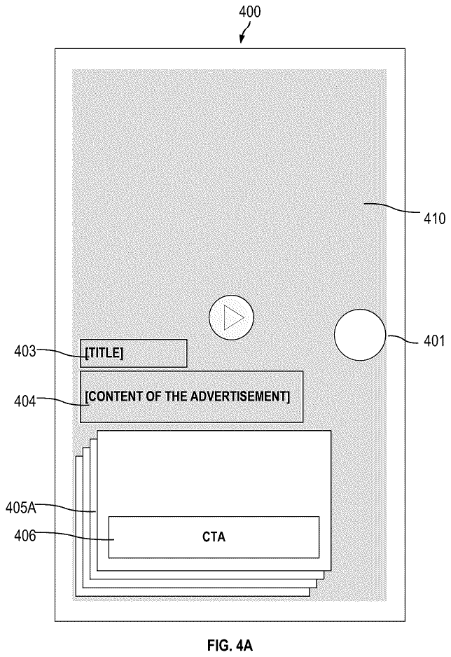

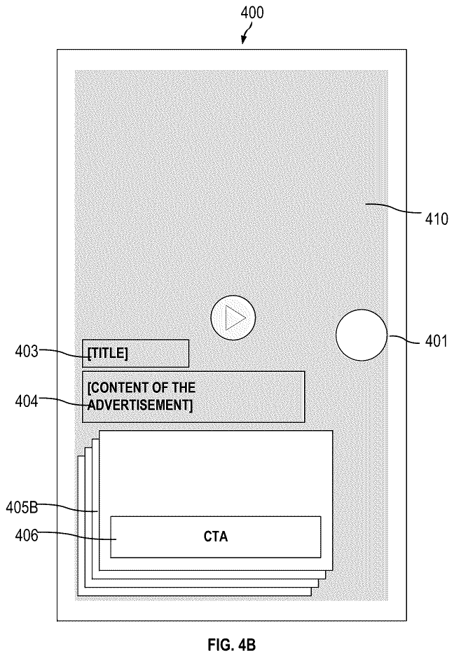

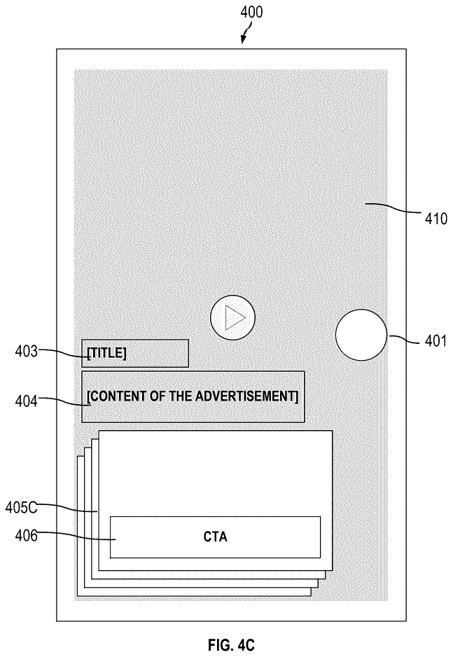

FIGS. 4A to 4C shows fragments corresponding to the three products in the video advertisement, respectively.

FIG. 4A shows the video fragment corresponding to the product A, wherein the product A is displayed in the main portion 410. In FIG. 4A, the product A is displayed with entry points including: a profile picture 401, a title 403, a content of the advertisement 404, a product card 405A, and a CTA button 406. In some implementations, in response to a user action associated with any of the entry points of FIG. 4A, the user may be redirected to a product page corresponding to the product A.

FIG. 4B shows the video fragment corresponding to the product B, wherein the product B is displayed in the main portion 410. In FIG. 4B, the product B is displayed with entry points including: the profile picture 401, the title 403, the content of the advertisement 404, a product card 405B, and the CTA button 406. In some implementations, in response to a user action associated with any of the entry points of FIG. 4B, the user may be redirected to a product page corresponding to the product B.

FIG. 4C shows the video fragment corresponding to the product C, wherein the product C is displayed in the main portion 410. In FIG. 4C, the product C is displayed with entry points including: the profile picture 401, the title 403, the content of the advertisement 404, a product card 405C, and the CTA button 406. In some implementations, in response to a user action associated with any of the entry points of FIG. 4C, the user may be redirected to a product page corresponding to the product C.

In the previous implementations, though the entry points (such as the profile picture 401, the title 403, the content of the advertisement 404 and the CTA button 406) in FIGS. 4A to 4C look the same from the user's perspective, however, they redirect the user to different product pages. In other words, the described techniques allow destination of an entry point to change with the change of the product displayed during the advertisement. In some other implementations, the CTA button 406 may be included as a part of and provided with the product card. In this case, the CTA buttons in FIGS. 4A to 4C are different buttons and appear visually different.

The described techniques permit a generated advertisement to link to multiple destinations, so that when the advertisement includes multiple products, users can be redirected to different destinations, where each of the different destinations may correspond to one product of the multiple products. Further, the described techniques provide the multiple products with multiple entry points that can show product information. By making the product information shown on the entry point change with the change of the displayed advertised products, the important parameters of the currently displayed product may be provided to the users. The described techniques also permit the users to be further redirected to the product page corresponding to the currently displayed product by performing user actions associated with the entry points displayed with the currently displayed product, so as to increase the conversion rate of the advertisement.

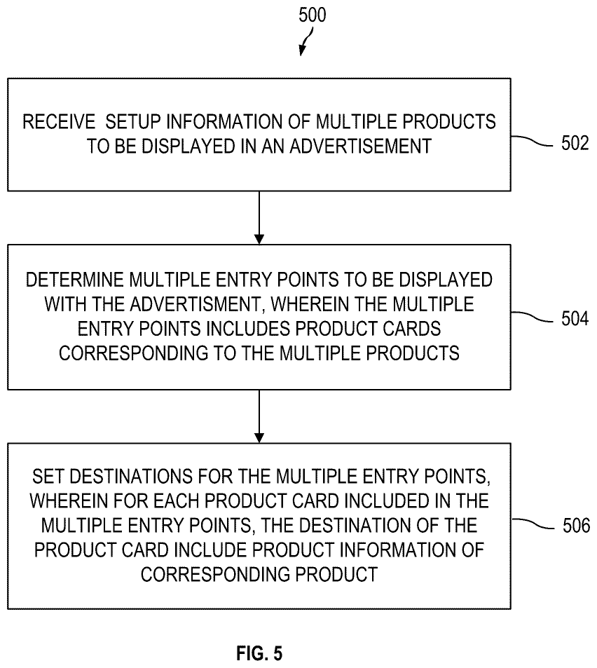

FIG. 5 is a flowchart of an example process 500 for generating advertisements that are linked to multiple destinations. In some implementations, the example process 500 can be implemented by the advertisement software platform 110 shown in FIG. 1 to generate the advertisement within the advertisement software platform 110. The operations shown in process 500 may not be exhaustive and that other operations can be performed as well before, after, or in between any of the illustrated operations. Further, some of the operations may be omitted, or performed simultaneously or in a different order than shown in FIG. 5.

At 502, setup information of multiple products to be displayed in an advertisement is received at the advertisement software platform 110. In some implementations, the setup information includes a product catalog, such as the catalog 200 shown in FIG. 2. In some implementations, the product catalog includes product parameters for each of the multiple products. For example, the product catalog may include parameters such as title of the product, the product ID, brand name, model or size of the product, manufacturing year, retail price, color, etc.

At 504, multiple entry points are determined, at the advertisement software platform 110, to be displayed with the advertisement. In some implementations, the entry point can be displayed in the format of profile pictures, CTA buttons, product cards, inventory cards, title, content of the advertisement, etc. In some implementations, the multiple entry points include multiple product cards, and each product card corresponds to one of the multiple products. In some implementations, each product card is set to be displayed with its corresponding product. In some other implementations, the multiple entry points include an inventory card, where the inventory card corresponds to inventory information of all the multiple products.

At 506, destinations are set, at the advertisement software platform 110, for the multiple entry points. In some implementations, setting destinations for the multiple entry points includes setting destinations for the multiple product cards included in the multiple entry points, wherein for each product card, the destination includes product information of the corresponding product that set to be displayed with the product card. In some implementations, destinations of the multiple entry points may be obtained by retrieval from the product catalog based on parameters of the product that the entry points are set to be displayed with. For example, in response to determining that an entry point is set to be displayed with a product A, retrieve the product catalog based on the parameters of the product A to obtain information corresponding to the product A, and set the web page of the product A as the destination of the entry point. In some implementations, setting destinations for the multiple entry points further includes setting destinations for the inventory card, wherein the destination of the inventory card may include inventory information of the multiple products.

In some implementations, more than one entry point is set to be displayed with one of the multiple products in the advertisement. In this case, destinations of the entry points are the same destination that includes information of the products displayed with the entry points. As an example, a product card, a CTA button and a profile picture are set to be displayed with a certain product in the advertisement. In this example, the product page of that certain product is set as the destination of the product card, the destination of the CTA button and the destination of the profile picture. Therefore, when the advertisement being viewed by a user, in response to user actions (such as click operation) associated with any one of the product card, the CTA button and the profile picture, the user can be redirected to the product page that includes the information of that certain product. Similarly, by setting different destinations for entry points that set to be displayed with different products, the described techniques allow user to be redirect to different product pages by clicking various entry points.

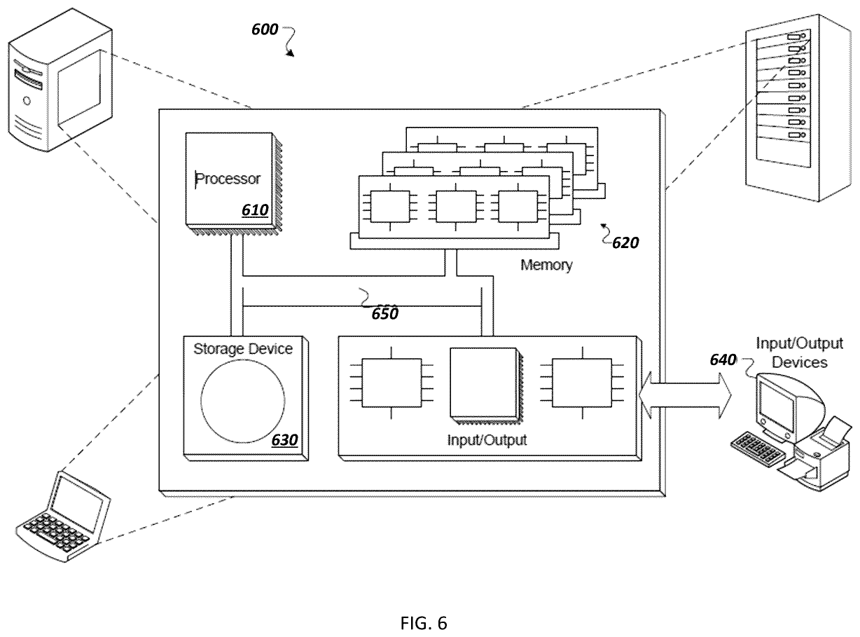

In some implementations, the above process 500 may also be performed by a system of one or more computers (e.g., the computer system 600 of FIG. 6), located in one or more locations, and programmed appropriately in accordance with this specification.

FIG. 6 is an example computer or computer-implemented system 600. The system 600 can be used for the operations described in association with the implementations described herein. For example, the system 600 may be included in computing devices of the one or more online components and/or the one or more offline components. The system 600 includes a processor 610, a memory 620, a storage device 630, and an input/output device 640. The components 610, 620, 630, and 640 are interconnected using a system bus 650. The processor 610 is capable of processing instructions for execution within the system 600. In some implementations, the processor 610 is a single-threaded processor. The processor 610 is a multi-threaded processor. The processor 610 is capable of processing instructions stored in the memory 620 or on the storage device 630 to display graphical information for a user interface on the input/output device 640.

The memory 620 stores information within the system 600. In some implementations, the memory 620 is a computer-readable medium. The memory 620 can be a volatile memory unit or a non-volatile memory unit. The storage device 630 is capable of providing mass storage for the system 600. The storage device 630 is a computer-readable medium. The storage device 630 may be a floppy disk device, a hard disk device, an optical disk device, or a tape device. The input/output device 640 provides input/output operations for the system 600. The input/output device 640 includes a keyboard and/or pointing device. The input/output device 640 includes a display unit for displaying graphical user interfaces.

In this specification the term “engine” will be used broadly to refer to a software based system or subsystem that can perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

Embodiments of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any disclosure or on the scope of what may be claimed, but rather as descriptions of features that may be specific to particular embodiments of particular disclosures. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially be claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer-implemented method for generating an advertisement linked to multiple destinations, comprising:
receiving, by an advertisement software platform, setup information of a plurality of products to be displayed in the advertisement;
determining a plurality of entry points to be displayed with the advertisement, wherein the plurality of entry points comprises a plurality of product cards corresponding to the plurality of products, each product card of the plurality of product cards is set to be displayed with a corresponding product among the plurality of products;
setting destinations for the plurality of product cards, wherein for each product card of the plurality of product cards, a destination of each product card comprises product information of a corresponding product displayed with each product card; and
generating the advertisement as a video advertisement comprising a plurality of video fragments played in a temporal sequence, wherein, during playback of the video advertisement, a product card corresponding to a product displayed in a currently played video fragment is displayed with the video advertisement and linked to a product page corresponding to the product displayed in the currently played video fragment, and wherein, in response to a change from a first product displayed in a first video fragment to a second product displayed in a second video fragment, a displayed product card and the product page linked to the displayed product card are dynamically changed from a first product card and a first product page corresponding to the first product to a second product card and a second product page corresponding to the second product.

2. The computer-implemented method of claim 1, wherein the setup information comprises a product catalog, and the product catalog comprises product parameters for each of the plurality of products.

3. The computer-implemented method of claim 2, wherein the setting destinations for the plurality of product cards comprises, for each product card of the plurality of product cards:
retrieving a destination of each product card from the product catalog based on product parameters of the corresponding product displayed with each product card.

4. The computer-implemented method of claim 1, further comprising:
in response to receiving, from a user, a user action associated with each product card, directing the user to a website page comprising the product information of the corresponding product displayed with each product card.

5. The computer-implemented method of claim 1, wherein the plurality of entry points further comprises an inventory card, and the computer-implemented method further comprises:
setting a destination of the inventory card to a website page comprising inventory information of the plurality of products.

6. The computer-implemented method of claim 1, wherein the plurality of entry points is displayed in one or more formats consisting of: profile pictures, call-to-action (CTA) button, cards, or advertisement content.

7. The computer-implemented method of claim 6, further comprising: for each of the plurality of products,
displaying a product with one or more of the entry points, wherein the one or more of the entry points have a same destination, wherein the same destination comprises product information of the product.

8. One or more non-transitory computer-readable storage media storing one or more instructions that, when executable by one or more computers, cause the one or more computers to perform operations comprising:
receiving, by an advertisement software platform, setup information of a plurality of products to be displayed in an advertisement;
determining a plurality of entry points to be displayed with the advertisement, wherein the plurality of entry points comprises a plurality of product cards corresponding to the plurality of products, each product card of the plurality of product cards is set to be displayed with a corresponding product among the plurality of products;
setting destinations for the plurality of product cards, wherein for each product card of the plurality of product cards, a destination of each product card comprises product information of a corresponding product displayed with each product card; and
generating the advertisement as a video advertisement comprising a plurality of video fragments played in a temporal sequence, wherein, during playback of the video advertisement, a product card corresponding to a product displayed in a currently played video fragment is displayed with the video advertisement and linked to a product page corresponding to the product displayed in the currently played video fragment, and wherein, in response to a change from a first product displayed in a first video fragment to a second product displayed in a second video fragment, a displayed product card and the product page linked to the displayed product card are dynamically changed from a first product card and a first product page corresponding to the first product to a second product card and a second product page corresponding to the second product.

9. The one or more non-transitory computer-readable storage media of claim 8, wherein the setup information comprises a product catalog, and the product catalog comprises product parameters for each of the plurality of products.

10. The one or more non-transitory computer-readable storage media of claim 9, wherein the setting destinations for the plurality of product cards comprises, for each product card of the plurality of product cards:
retrieving a destination of each product card from the product catalog based on product parameters of the corresponding product displayed with each product card.

11. The one or more non-transitory computer-readable storage media of claim 8, further comprising:
in response to receiving, from a user, a user action associated with each product card, directing the user to a website page comprising the product information of the corresponding product displayed with each product card.

12. The one or more non-transitory computer-readable storage media of claim 8, wherein the plurality of entry points further comprises an inventory card, and the operations further comprise:
setting a destination of the inventory card to a website page comprising inventory information of the plurality of products.

13. The one or more non-transitory computer-readable storage media of claim 8, wherein the plurality of entry points is displayed in one or more formats consisting of: profile pictures, call-to-action (CTA) button, cards, or advertisement content.

14. The one or more non-transitory computer-readable storage media of claim 13, further comprising, for each of the plurality of products:
displaying a product with one or more of the entry points, wherein the one or more of the entry points have a same destination, wherein the same destination comprises product information of the product.

15. A computer-implemented system, comprising:
one or more computers; and
one or more computer memory devices interoperably coupled with the one or more computers and having non-transitory computer-readable storage media storing one or more instructions that, when executed by the one or more computers, perform one or more operations comprising:
receiving, by an advertisement software platform, setup information of a plurality of products to be displayed in an advertisement;
determining a plurality of entry points to be displayed with the advertisement, wherein the plurality of entry points comprises a plurality of product cards corresponding to the plurality of products, each product card of the plurality of product cards is set to be displayed with a corresponding product among the plurality of products;
setting destinations for the plurality of product cards, wherein for each product card of the plurality of product cards, a destination of each product card comprises product information of a corresponding product displayed with each product card; and
generating the advertisement as a video advertisement comprising a plurality of video fragments played in a temporal sequence, wherein, during playback of the video advertisement, a product card corresponding to a product displayed in a currently played video fragment is displayed with the video advertisement and linked to a product page corresponding to the product displayed in the currently played video fragment, and wherein, in response to a change from a first product displayed in a first video fragment to a second product displayed in a second video fragment, a displayed product card and the product page linked to the displayed product card are dynamically changed from a first product card and a first product page corresponding to the first product to a second product card and a second product page corresponding to the second product.

16. The computer-implemented system of claim 15, wherein the setup information comprises a product catalog, and the product catalog comprises product parameters for each of the plurality of products.

17. The computer-implemented system of claim 16, wherein the setting destinations for the plurality of product cards comprises, for each product card of the plurality of product cards:
retrieving a destination of each product card from the product catalog based on product parameters of the corresponding product displayed with each product card.

18. The computer-implemented system of claim 15, further comprising:
in response to receiving, from a user, a user action associated with each product card, directing the user to a website page comprising the product information of the corresponding product displayed with each product card.

19. The computer-implemented system of claim 15, wherein the plurality of entry points further comprises an inventory card, and the one or more operations further comprises:
setting a destination of the inventory card to a website page comprising inventory information of the plurality of products.

20. The computer-implemented system of claim 15, wherein the plurality of entry points is displayed in one or more formats consisting of: profile pictures, call-to-action (CTA) button, cards, or advertisement content, and
wherein the one or more operations further comprises, for each of the plurality of products:
displaying a product with one or more of the entry points, wherein the one or more of the entry points have a same destination, wherein the same destination comprises product information of the product.
